(19) United States
(12) Patent Application Publication
(10) Pub. No.: US 2019/0134674 A1
(43) Pub. Date: May 9, 2019

(54) CLEANING DEVICE, CLEANING SYSTEM AND COATING APPARATUS

(71) Applicant: HKC CORPORATION LIMITED, Shenzhen (CN)

(72) Inventor: Beizhou Huang, Shenzhen (CN)

(21) Appl. No.: 16/237,895

(22) Filed: Jan. 2, 2019

Related U.S. Application Data
(63) Continuation-in-part of application No. PCT/CN2018/072436, filed on Jan. 12, 2018.

(30) Foreign Application Priority Data
Oct. 25, 2017 (CN) 201721383988.X

(51) Int. Cl. B08B 1/00; B08B 3/04; B05B 14/00

(52) U.S. Cl. CPC B08B 1/008; B05B 14/00; B08B 3/04

(57) ABSTRACT

A cleaning device includes a cleaning assembly which includes a cleaning body, the cleaning body having a cleaning layer provided thereon, the cleaning layer being configured to make contact with a nozzle opening and having liquid adsorption characteristics; a cleaning assembly drive configured to drive the cleaning assembly to move relative to the nozzle opening along a surface of the nozzle opening, the cleaning assembly drive being coupled to the cleaning assembly; a cleaning solution container; and a cleaning solution delivery conduit having a solution inlet coupled to the cleaning solution container (3) and a solution outlet for spraying solution in the cleaning solution container onto the cleaning layer.

### CROSS-REFERENCES TO RELATED APPLICATION

This application is a continuation-in-part of International Patent Application No. PCT/CN2018/072436 with an international filing date of Jan. 12, 2018 designating US, now pending. The contents of all of the aforementioned applications, including any intervening amendments thereto, are incorporated herein by reference.

### BACKGROUND

The present disclosure relates to the technical field of cleaning devices, and more particularly to a cleaning device, a cleaning system and a coating apparatus.

In production and life, it is often necessary to spray some coating on the product. During the spraying process, some liquid inevitably remains on the nozzle. Currently the liquid is usually removed by means of gas adsorption so that the residual liquid on the nozzle can be absorbed. However the adsorption is often not clean and it is easy to cause the liquid to remain on the nozzle, which greatly affects.

### SUMMARY

In an embodiment of the present disclosure, a cleaning device is provided to solve the technical problem that the residual liquid on the nozzle cannot be effectively removed.

A cleaning device is disclosed, which includes:

a cleaning assembly including a cleaning body, the cleaning body is provided with a cleaning layer with liquid adsorption characteristics which is configured to contact with a nozzle opening;

a cleaning assembly drive configured to move the cleaning assembly relative to the nozzle opening along a surface of the nozzle opening, the cleaning assembly drive being coupled to the cleaning assembly;

a cleaning solution container; and

a cleaning solution delivery conduit having a solution inlet coupled to the cleaning solution container and a solution outlet for spraying solution in the cleaning solution container onto the cleaning layer.

Optionally, the cleaning assembly drive includes a guide rail and a linear drive motor configured to drive the cleaning assembly to slide along the guide rail.

Optionally, the cleaning body has a cylindrical shape.

Optionally, the cleaning body is formed with a through hole in communication with the cleaning solution delivery conduit.

Optionally, a diameter of the through hole is the same as an inner diameter of the cleaning solution delivery conduit.

Optionally, the cleaning solution delivery conduit is integrally formed of elastic material.

Optionally, the cleaning device includes a plurality of the cleaning solution delivery conduits and the cleaning body is provided with a plurality of the through holes, each of the plurality of the cleaning solution delivery conduits being corresponding to a respectively one of the plurality of through holes.

Optionally, the cleaning solution delivery conduit is provided with a control valve configured to control a flow of the solution flowing through the cleaning solution delivery conduit.

Optionally, the cleaning solution delivery conduit is provided with a plurality of the control valves.

Optionally, the plurality of the control valves are arranged at equal intervals in the cleaning solution delivery conduit.

Optionally, the control valve is a one-way valve.

Optionally, the cleaning layer is nylon cloth layer which is bonded to the cleaning body.

Optionally, the cleaning layer includes a plurality of the nylon cloth layers stacked on one another.

Optionally, an adhesive layer is provided between adjacent two of the plurality of the nylon cloth layers.

Optionally, the adhesive layer is formed with permeation holes for liquid permeation therethrough.

Optionally, a plurality of the permeable holes are uniformly distributed over and in the entire surface of the adhesive layer.

Optionally, one side of the cleaning assembly is provided with a vacuum suction device fixed to the cleaning body and configured to extract residual liquid in the nozzle.

Optionally, the cleaning device further includes a cleaning solution moving device for moving the cleaning solution in the cleaning solution container to the cleaning solution deliver conduit.

A cleaning system is further disclosed in the present disclosure. The cleaning system includes a collection plate and the cleaning device described above, the liquid collection plate being located below the cleaning assembly.

A coating apparatus is further disclosed in the present disclosure. The coating apparatus includes a platform and the cleaning device described above, the cleaning device being disposed on the platform.

In an embodiment of the present disclosure, by providing a cleaning layer 122 having liquid adsorption characteristics on the cleaning body 121, a cleaning assembly 12 is formed by the cleaning body 121 and the cleaning layer 122. Driven by cleaning assembly drive, the cleaning assembly 12 moves along the surface of the nozzle opening to clean the nozzle opening, therefore the surface of the nozzle opening can be well cleaned. Moreover, the entire cleaning process is very fast, thereby increasing the production efficiency. In addition, the cleaning solution in the cleaning solution container is delivered to the cleaning layer 122 sequentially through the solution inlet and the solution outlet of the cleaning solution delivery conduit 4, and the cleaning solution in the cleaning layer 122 can enhance the effect of wiping the surface of the nozzle opening.

### BRIEF DESCRIPTION OF THE DRAWINGS

In order to more clearly illustrate the technical solutions in the embodiments of the present disclosure, the drawings used in the embodiments or the prior art description will be briefly described below. It is obvious that the drawings in the following description are only some embodiments of the present disclosure. To those skilled in the art, other drawings may be obtained from these drawings without paying any creative work.

FIG. 1 is a schematic structural view of a cleaning device before cleaning according to an embodiment of the present disclosure;

FIG. 2 is a schematic structural view of a cleaning device in cleaning according to an embodiment of the present disclosure;

FIG. 3 is a schematic structural view of a cleaning device after cleaning according to an embodiment of the present disclosure;

FIG. 4 is a schematic structural view of a cleaning system according to an embodiment of the present disclosure; and

FIG. 5 shows the layer structure of a cleaning layer according to an embodiment of the present disclosure.

### DESCRIPTION OF THE PREFERRED EMBODIMENTS

In order to make the technical problems to be solved by the present disclosure, technical solutions and beneficial effects more clear, the present disclosure will be further described in detail below with reference to the accompanying drawings and embodiments. It should be understood that the specific embodiments described herein are merely illustrative of the present disclosure and are not intended to limit the present disclosure.

It should be noted that when an element is referred to as being “fixed” or “arranged” on another element, it may be directly or indirectly on another element. When an element is referred to as being “connected” to another element, it may be directly or indirectly connected to another element.

It should be understood that the orientation or position relationship indicated by the terms “length”, “width”, “upper”, “lower”, “front”, “back”, “left”, “right”, “vertical”, “horizontal”, “top”, “bottom”, “inside”, “outside” or the like is based on the orientation or position relationship shown in the drawings, and is merely for convenience of description of the present disclosure and simplifying description, instead of indicating or implying that the device or the component referred to must have a particular orientation or be constructed and operated in a particular orientation, and therefore should not be construed to limit the present disclosure.

Moreover, the terms “first” and “second” are used for descriptive purposes only and should not be construed as indicating or implying relative importance or implicitly indicating the number of the technical features indicated. Thus, a feature defined by “first” and “second” may include one or more explicitly or implicitly. In the description of the present disclosure, the term “a plurality of” means two or more, unless otherwise specifically defined.

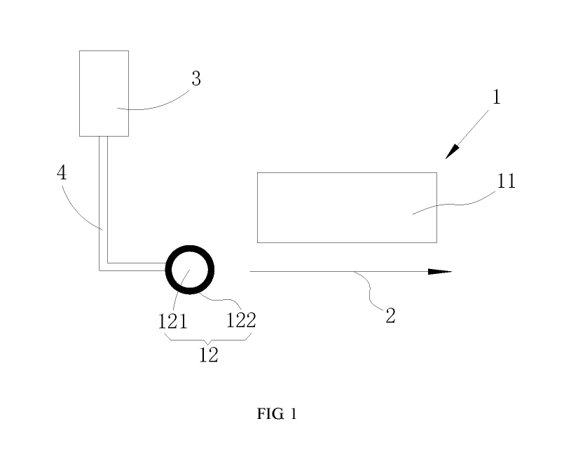

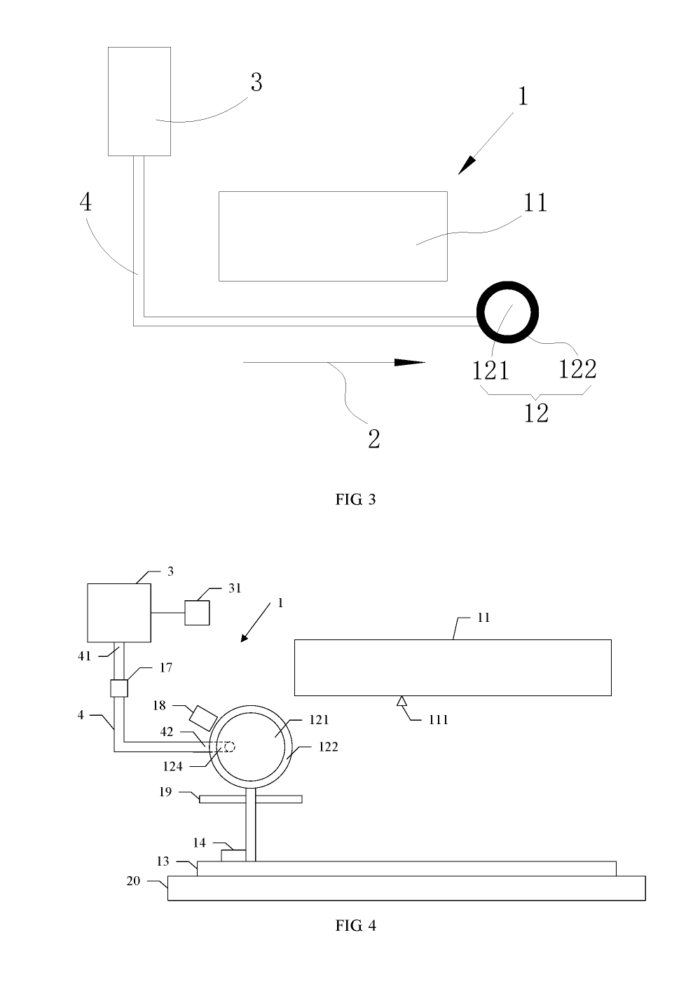

Referring to FIG. 1 and FIG. 3 together, a cleaning device 1 according to an embodiment of the present disclosure will be described. The cleaning device 1 is configured to clean a nozzle opening 111 on a spray nozzle 11 and includes:

a cleaning assembly 12, which includes a cleaning body 121, the cleaning body having a cleaning layer 122 provided thereon, the cleaning layer 122 being configured to make contact with the nozzle opening 111 and having liquid adsorption characteristics;.

a cleaning assembly drive, which is configured to drive the cleaning assembly 12 to move relative to the nozzle opening along a surface of the nozzle opening, the cleaning assembly drive being coupled to the cleaning assembly 12;

a cleaning solution container 3; and

a cleaning solution delivery conduit 4, which has a solution inlet 41 coupled to the cleaning solution container 3 and a solution outlet 42 for spraying the solution in the cleaning solution container 3 onto the cleaning layer 122.

By providing a cleaning layer 122 having liquid adsorption characteristics on the cleaning body 121, a cleaning assembly 12 is formed by the cleaning body 121 and the cleaning layer 122. Driven by the cleaning assembly drive, the cleaning assembly 12 moves along the surface of the nozzle opening to clean the nozzle opening, therefore the liquid on the surface of the nozzle opening can be well cleaned. Moreover, the entire cleaning process is very fast, thereby increasing the production efficiency. In addition, the solution in the cleaning solution container is delivered to the cleaning layer 122 sequentially through the solution inlet 41 and the solution outlet 42 of the cleaning solution delivery conduit 4, and the solution in the cleaning layer 122 can enhance the effect of wiping the surface of the nozzle opening.

The cleaning body 121 is configured to hold the cleaning layer 122. The cleaning body 121 may be a cylinder, a prism, or be in other irregular shape, as long as the cleaning layer 122 can be kept on the cleaning body 121 and the cleaning body 121 can be driven by the cleaning assembly to clean the nozzle opening, which is not limited here.

The number of the cleaning body 121 may be one or more. When the number of the cleaning body 121 is more than one, the plurality of cleaning bodies 121 may be arranged in a plurality of rows or in a plurality of columns. The row and the column are perpendicular to each other. In other embodiments, the plurality of cleaning bodies 121 may be arranged in other irregular manners, as long as the cleaning body 121 may effectively clean the nozzle openings. Moreover, in this embodiment, each of the nozzle openings corresponds to a respective one of the cleaning bodies 121, but in other embodiments, one cleaning body 121 may simultaneously clean a plurality of nozzle openings, which is not limited herein.

The cleaning solution container 3 is configured to accommodate the solution (not shown in the figures), and the cleaning solution delivery conduit 4 for delivering the solution in the cleaning solution container 3 to the cleaning layer 122 is disposed between the cleaning solution container 3 and the cleaning assembly 12.

The solution in the cleaning solution container 3 can be conveniently delivered to the cleaning layer 122 through the cleaning solution delivery conduit 4.

The solution is stored in the cleaning solution container 3, so it is convenient to supplement the solution. Furthermore, the solution can be delivered to the cleaning layer 122 through the cleaning solution delivery conduit 4 to continuously supply the solution required by the cleaning nozzle 11 to the cleaning layer.

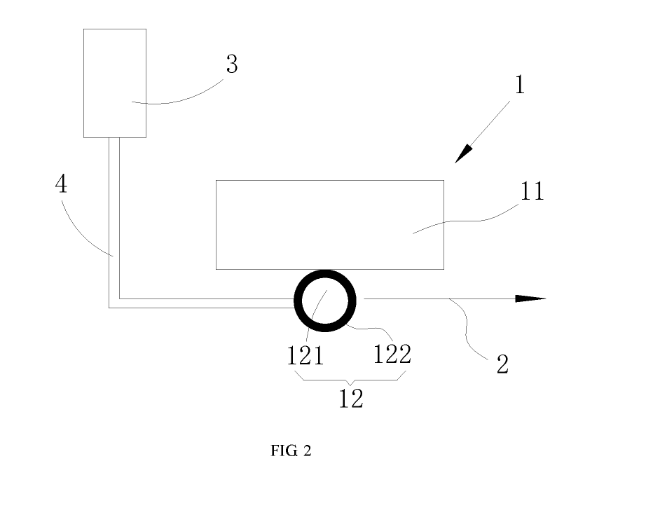

Optionally, referring to FIG. 1 to FIG. 4, as a specific embodiment of the cleaning device 1 provided by the present disclosure, the cleaning assembly drive includes a guide rail 13 and a linear drive motor 14 configured to drive the cleaning assembly 12 to slide along the guide rail. In this way, the cleaning assembly 12, driven by the linear drive motor, can slide along the guide rail, so that the nozzle 11 can be very conveniently cleaned by the cleaning assembly 12, where only the linear drive motor need be controlled. In one embodiment, the cleaning assembly 12 cleans the nozzle 11 when the cleaning assembly 12 moves along the cleaning direction 2, and the cleaning assembly 12 remains detached from the nozzle 11 when the cleaning assembly 12 moves in the direction opposite to the cleaning direction 2. Thus, the contamination of the nozzle 11, which may be caused because the cleaning unit 12 cleans the nozzle 11 back and forth, will be not occurred.

Optionally, referring to FIG. 1 to FIG. 4, as one embodiment of the cleaning device 1 provided by the present disclosure, the cleaning body 121 is in the shape of a cylinder. Thus, it is relatively easy to produce the cleaning body 121. In addition, when the region of the cleaning layer 122 making contact with the nozzle 11 is contaminated, only a slightly rotation of the cleaning body 121 is required such that other region of the cleaning layer 122 can be used to clean the nozzle 11, which avoids the need of replacing the cleaning layer 122 frequently.

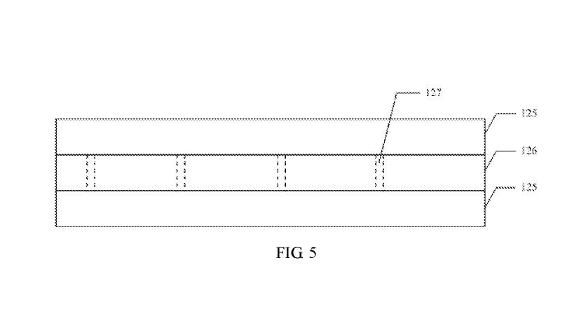

Optionally, referring to FIG. 1 to FIG. 4, as one embodiment of the cleaning device 1 provided by the present disclosure, the cleaning body 121 is formed with a through hole 124, and the through hole is in communication with the cleaning solution delivery conduit 4. By this configuration, the solution in the cleaning solution delivery conduit 4 can be delivered to the cleaning layer 122 through the through hole. Optionally, the number of the through hole is more than one, which can avoids the situation that the solution cannot be efficiently delivered to the cleaning layer 122 due to the blocking of a through hole. In FIG. 4, the cleaning body 121 is in the shape of a cylinder and the cleaning layer 122 is covered on the circumferential surface of the cleaning body. And the cleaning solution delivery conduit 4 is arranged at one axial side of the cleaning body. The through hole in the cleaning body for delivering the solution may be formed by an axial hole in communication with the cleaning solution delivery conduit 4 and a radial hole in communication with the axial hole and the cleaning layer.Optionally, referring to FIG. 1 to FIG. 3, as a specific embodiment of the cleaning device 1 provided by the present disclosure, the diameter of the through hole is the same as the inner diameter of the cleaning solution delivery conduit 4. Thus, when the liquid is delivered from the cleaning solution delivery conduit 4 to the through hole, the flow of the liquid is relatively stable, and the decrease of the hydraulic pressure, which is caused because the diameter of the through hole is greater than the inner diameter of the cleaning solution delivery conduit 4, will not be happened, and the increase of the hydraulic pressure, which is caused because the diameter of the through hole is smaller than the inner diameter of the cleaning solution delivery conduit 4, will not be happened either.

Optionally, referring to FIG. 1 to FIG. 3, as a specific embodiment of the cleaning device 1 provided by the present disclosure, the cleaning liquid infusion pipe 4 is integrally formed of elastic material. Thus, when the cleaning assembly drive drives the cleaning assembly 12 to move, the elastic cleaning solution delivery conduit 4 is less prone to cracking, which ensures the normal operation of the cleaning assembly 12.

Optionally, referring to FIG. 1 to FIG. 3, as a specific embodiment of the cleaning device 1 provided by the present disclosure, the cleaning device comprises a plurality of the cleaning solution delivery conduits 4, the cleaning body 121 is provided with a plurality of through holes and each of the plurality of the cleaning solution delivery conduits corresponds to a respectively one of the plurality of through holes. By this configuration, when installing the cleaning solution delivery conduits 4, it is easy to match the cleaning solution delivery conduits respectively with the through holes and therefore the installation is easy.

Optionally, referring to FIG. 1 to FIG. 4, as a specific embodiment of the cleaning device 1 provided by the present disclosure, the cleaning solution delivery conduit 4 is provided with a control valve 17 configured to control the flow of the cleaning solution flowing through the cleaning solution delivery conduit 4. Thus, the control valve can conveniently control the flow of the solution passing through the cleaning solution delivery conduit 4.

Optionally, referring to FIG. 1 to FIG. 3, as a specific embodiment of the cleaning device 1 provided by the present disclosure, the cleaning solution delivery conduit is provided with a plurality of the control valves. Thus, when one or some of the plurality of the control valves fails, the remaining normal control valves can also ensure the control of the flow of the cleaning solution delivery conduit 4.

Optionally, referring to FIG. 1 to FIG. 3, as a specific embodiment of the cleaning device 1 provided by the present disclosure, the plurality of control valves are arranged at equal intervals in the cleaning solution delivery conduit 4. Thus, it is convenient to open or close the control valve.

Optionally, referring to FIG. 1 to FIG. 3, as a specific embodiment of the cleaning device 1 provided by the present disclosure, the control valve is a one-way valve. Thus, reverse flow of the liquid in the cleaning solution delivery conduit 4, which means that the liquid in the cleaning layer 122 flows back into the cleaning solution container 3 through the cleaning solution delivery conduit 4, can be avoided, thereby ensuring cleaning of the cleaning solution container 3.

Optionally, referring to FIG. 1 to FIG. 3, as a specific embodiment of the cleaning device 1 provided by the present disclosure, the cleaning layer 122 is a nylon cloth layer which is bonded to the cleaning body 121. Thus, the nylon cloth can effectively adsorb the liquid on the nozzle 11, and the nylon cloth is not easy to produce dust, and the cleanliness of the nozzle 11 can be well assured.

Optionally, referring to FIG. 1 to FIG. 3, as a specific embodiment of the cleaning device 1 provided by the present disclosure, the cleaning layer 122 includes a plurality of nylon cloth layers stacked on one another. Thus, by stacking a plurality of nylon cloth layers, relatively thick buffer layers are provided for the cleaning layer 122 when it contacts the nozzle opening. Moreover, the plurality of nylon cloth layers can absorb more liquid, thereby ensuring the stability of the cleaning layer 122.

Optionally, referring to FIG. 1 to FIG. 5, as a specific embodiment of the cleaning device 1 provided by the present disclosure, an adhesive layer 126 is provided between adjacent two nylon cloth layers 125. Thus, the adhesive layer ensures a stable bonding relationship between the nylon cloths, and the affecting of the wiping effect of the cleaning layer 122, due to the relative sliding between the nylon cloths, can be avoided during the cleaning of the nozzle opening.

Optionally, referring to FIG. 1 to FIG. 5, as a specific embodiment of the cleaning device 1 provided by the present disclosure, the adhesive layer is provided with permeation holes 127 for liquid permeation therethrough. Thus, it is allowed to permeate liquid into different nylon cloths through the permeation hole.

Optionally, referring to FIG. 1 to FIG. 3, as a specific embodiment of the cleaning device 1 provided by the present disclosure, a plurality of the permeable holes are uniformly distributed over and in the entire surface of the adhesive layer. Thus, the liquid can be more uniformly permeated into the different nylon cloths through the permeate hole.

Optionally, referring to FIG. 1 to FIG. 4, as a specific embodiment of the cleaning device 1 provided by the present disclosure, one side of the cleaning assembly 12 is provided with a vacuum suction device 18, the vacuum suction device being fixed to the cleaning body 121 and configured to extract residual liquid in the nozzle. Thus, the vacuum suction device can effectively re-absorb the liquid in the nozzle 11 which is not completely cleaned by the cleaning assembly 12, so that the nozzle 11 can be cleaned more cleanly.

Optionally, referring to FIG. 1 to FIG. 4, as a specific embodiment of the cleaning device 1 provided by the present disclosure, the cleaning device 1 further includes a cleaning solution moving device 31 for moving the cleaning solution in the cleaning solution container 3 to the cleaning solution deliver conduit. Thus, it is very convenient to supplement the cleaning layer 122 with the cleaning solution through the cleaning liquid driving device.

Optionally, referring to FIG. 1 to FIG. 3, as a specific embodiment of the cleaning device 1 provided by the present disclosure, a pressure sensor (not shown in the figures) is provided between the cleaning layer 122 and the cleaning body 121 and configured to detect the pressure applied by the nozzle 11 on the cleaning assembly 12. The cleaning device 1 further includes a processer (not shown in the figures) configured to process the information of the pressure sensor. The processer is electrically connected to the cleaning assembly drive and the pressure sensor respectively. Thus, the pressure sensor can effectively detect the pressure applied by the cleaning assembly 12 on the nozzle 11, and the processer receives the information of the pressure sensor and transmits the information to the cleaning assembly drive to adjust the pressure. By adjusting the pressure, the cleanliness of the cleaning nozzle 11 and the cleaning assembly 12 can be optimized.

The present disclosure further provides a cleaning system comprising a liquid collection plate 19 and a cleaning device 1. The liquid collection plate 19 is located below the cleaning assembly 12.

The cleaning system provided by the present disclosure has an effect in that, by using the cleaning device 1 described above, the cleaning layer 122 having liquid adsorption characteristics is provided on the cleaning body 121, a cleaning assembly 12 is formed by the cleaning body 121 and the cleaning layer 122. Driven by the cleaning assembly drive, the cleaning assembly 12 moves along the surface of the nozzle opening to clean the nozzle opening, therefore the liquid on the surface of the nozzle opening can be well cleaned. Moreover, the entire cleaning process is very fast, thereby increasing the production efficiency. In addition, the solution in the cleaning solution container is delivered to the cleaning layer 122 sequentially through the solution inlet 41 and the solution outlet 42 of the cleaning solution delivery conduit 4, and the solution in the cleaning layer 122 can enhance the effect of wiping the surface of the nozzle opening.

The present disclosure further provides a coating apparatus comprising a platform 20 and the cleaning device 1 which is disposed on the platform.

The coating apparatus provided by the present disclosure has an effect in that, by using the cleaning device 1 described above, the cleaning layer 122 having liquid adsorption characteristics is provided on the cleaning body 121, a cleaning assembly 12 is formed by the cleaning body 121 and the cleaning layer 122. Driven by the cleaning assembly drive, the cleaning assembly 12 moves along the surface of the nozzle opening to clean the nozzle opening, therefore the liquid on the surface of the nozzle opening can be well cleaned. Moreover, the entire cleaning process is very fast, thereby increasing the production efficiency. In addition, the solution in the cleaning solution container is delivered to the cleaning layer 122 sequentially through the solution inlet 41 and the solution outlet 42 of the cleaning solution delivery conduit 4, and the solution in the cleaning layer 122 can enhance the effect of wiping the surface of the nozzle opening.

The above shows only some embodiments of the present disclosure, and are not intended to limit the present disclosure. Any modifications, equivalent substitutions and improvements made within the spirit and principles of the present disclosure are included in the scope of protection of the present disclosure.

What is claimed is:

1. A cleaning device comprising:
a cleaning assembly comprising a cleaning body, the cleaning body is provided with a cleaning layer with liquid adsorption characteristics which is configured to contact with a nozzle opening;
a cleaning assembly drive configured to move the cleaning assembly relative to the nozzle opening along a surface of the nozzle opening, the cleaning assembly drive being coupled to the cleaning assembly;
a cleaning solution container; and
a cleaning solution delivery conduit having a solution inlet coupled to the cleaning solution container and a solution outlet for spraying solution in the cleaning solution container onto the cleaning layer.

2. The cleaning device according to claim 1, wherein the cleaning assembly drive includes a guide rail and a linear drive motor configured to drive the cleaning assembly to slide along the guide rail.

3. The cleaning device according to claim 1, wherein the cleaning body has a cylindrical shape.

4. The cleaning device according to claim 1, wherein the cleaning body is formed with a through hole in communication with the cleaning solution delivery conduit.

5. The cleaning device according to claim 4, wherein a diameter of the through hole is the same as an inner diameter of the cleaning solution delivery conduit.

6. The cleaning device according to claim 4, wherein the cleaning solution delivery conduit is integrally formed of elastic material.

7. The cleaning device according to claim 4, wherein the cleaning device comprises a plurality of the cleaning solution delivery conduits and the cleaning body is provided with a plurality of the through holes, each of the plurality of the cleaning solution delivery conduits being corresponding to a respectively one of the plurality of through holes.

8. The cleaning device according to claim 1, wherein the cleaning solution delivery conduit is provided with a control valve configured to control a flow of the solution flowing through the cleaning solution delivery conduit.

9. The cleaning device according to claim 8, wherein the cleaning solution delivery conduit is provided with a plurality of the control valves.

10. The cleaning device according to claim 9, wherein the plurality of the control valves are arranged at equal intervals in the cleaning solution delivery conduit.

11. The cleaning device according to claim 8, wherein the control valve is a one-way valve.

12. The cleaning device according to claim 1, wherein the cleaning layer is a nylon cloth layer which is bonded to the cleaning body.

13. A cleaning device according to claim 12, wherein the cleaning layer comprises a plurality of the nylon cloth layers stacked on one another.

14. The cleaning device according to claim 13, wherein an adhesive layer is provided between adjacent two of the plurality of the nylon cloth layers.

15. The cleaning device according to claim 14, wherein the adhesive layer is formed with permeation holes for liquid permeation therethrough.

16. The cleaning device according to claim 15, wherein a plurality of the permeable holes are uniformly distributed over and in the surface of the adhesive layer.

17. A cleaning device according to claim 1, wherein one side of the cleaning assembly is provided with a vacuum suction device fixed to the cleaning body and configured to extract residual liquid in the nozzle.

18. A cleaning device according to claim 1, further comprising a cleaning solution moving device for moving the cleaning solution in the cleaning solution container to the cleaning solution deliver conduit.

19. A cleaning system comprising a liquid collection plate and a cleaning device which comprises:
a cleaning assembly comprising a cleaning body, the cleaning body is provided with a cleaning layer with liquid adsorption characteristics which is configured to contact with a nozzle opening;
a cleaning assembly drive configured to move the cleaning assembly relative to the nozzle opening along a surface of the nozzle opening, the cleaning assembly drive being coupled to the cleaning assembly;
a cleaning solution container; and
a cleaning solution delivery conduit having a solution inlet coupled to the cleaning solution container and a solution outlet for spraying solution in the cleaning solution container onto the cleaning layer;
wherein the liquid collection plate is located below the cleaning assembly.

20. A coating apparatus comprising a platform and a cleaning device which comprises:
a cleaning assembly comprising a cleaning body, the cleaning body is provided with a cleaning layer with liquid adsorption characteristics which is configured to contact with a nozzle opening;
a cleaning assembly drive configured to move the cleaning assembly relative to the nozzle opening along a surface of the nozzle opening, the cleaning assembly drive being coupled to the cleaning assembly;
a cleaning solution container; and
a cleaning solution delivery conduit having a solution inlet coupled to the cleaning solution container and a solution outlet for spraying solution in the cleaning solution container onto the cleaning layer;
wherein the cleaning device is disposed on the platform.
